(19) United States
(12) Patent Application Publication
(10) Pub. No.: US 2016/0031546 A1
(43) Pub. Date: Feb. 4, 2016

(54) LIFT-REDUCING APPARATUS FOR AIRCRAFT WINGS

(71) Applicants: EADS UK LIMITED, London (GB); AIRBUSGROUP LIMITED, London (GB)

(72) Inventor: Stephen Rolston, Bristol (GB)

(73) Assignee: Airbusgroup Limited, London (GB)

(21) Appl. No.: 14/780,074

(22) PCT Filed: Mar. 26, 2014
(86) PCT No.: PCT/GB2014/050958

§ 371 Date: Sep. 25, 2015

(30) Foreign Application Priority Data
Mar. 26, 2013 (GB) 1305461.4

(51) Int. Cl. B64C 3/58; B64C 9/08

(52) U.S. Cl. CPC B64C 3/58; B64C 9/08

(57) ABSTRACT

Modern aircraft wings generally have a lower surface the rear part of which is concave over at least some of its length, for additional lift. Sometimes it is desirable to reduce the wing lift, for instance during turbulence. To this end the wing 1 has, located at least partly in or forward of this concave part and forward of the trailing edge, a spoiler device such as a deployable spoiler 20 operable to change between a configuration in which the surface is uninterrupted and one in which the device separates flow, so as to reduce local lift over the concave portion. An actuator 26 can be provided for deploying the spoiler, and an upper spoiler 40 can also be present, operated by the same or a separate actuator. Alternatively the spoiler device can include a flexible or deforming material 120 operable to protrude from the wing surface.

The invention relates to aircraft wings, and particularly such wings for transport aeroplanes, where it is desirable to reduce or limit the maximum load on the wing due to lift at the extremes of the flight envelope. This function is often known as the Load Alleviation Function or LAF. Such loads can arise from manoeuvres, continuous turbulence or discrete gusts.

For the outer parts of the wing the ailerons can be used to reduce lift, and normally spoilers are also present on the upper surface, which can be deployed as needed. This reduction in lift in the outboard and midboard wing will result in a more favourable distribution of load along the wing span giving a reduction in bending moment at the wing root.

An example of spoilers used for locally modifying lift is given in US 2009/266938 (Airbus). Another Airbus application, WO 2006/108579, uses a sliding spoiler or cover to bridge the gap formed when a flap is deployed during start and landing, in order to reduce air resistance and noise. A hinged shaped spoiler for use in lateral control, instead of an aileron, can be installed in the upper surface of a wing as shown in GB 1018097 (Shin-Mitsubishi Jukogyo KK). A control system acting on outboard flaps to reduce wing root bending moment (Maneuver load alleviation or MLA) is disclosed in U.S. Pat. No. 4,796,192 (Lewis/Boeing). Finally, EP 239138 also by Boeing describes aileron-mounted trailing-edge flaps used as air brakes or for additional lift.

The invention has particular applicability to the wings of transport aircraft designed to operate in cruise at transonic speeds, i.e. near the speed of sound, generally in the range Mach 0.70-0.85.

The invention is defined in claim 1 as an aircraft wing and in claim 11 as a method of controlling an aircraft.

In embodiments of the invention an aircraft wing has in the rear half of its lower surface, but forward of the trailing edge, a device operable to change between a configuration in which the wing surface is uninterrupted and one in which the device causes separation of flow, so as to reduce local lift.

The invention also relates to a method of reducing lift, using a spoiler device on a wing lower surface having a concave rear part; in which the spoiler device, when deployed, and particularly during cruise, causes flow separation at the concave rear part of this lower surface, thus reducing lift.

Constructions using the invention fit a spoiler or similar device in the lower surface of the wing to reduce the lift component from the rear part of the wing, aft of maximum thickness. In modern aircraft this rear part, or a substantial part of it, is usually concave, in order to add a lift component from the rear section. This is known as an “aft-loaded” wing section. Since it is not generally possible to induce flow separation in the forward part of the wing, the invention concentrates on fitting the device in the rear part. Normally it would be located between the maximum thickness of the aerofoil and the beginning of the concave part, possibly slightly overlapping the beginning of the concave part.

The spoiler device would fit best in particular in the mid to outer part of the wing span, generally underneath where the upper surface spoilers would be. The further out the spoiler device, the greater the effect on the moment at the wing root. For much of the length (span) of the wing, the trailing edge would itself be constituted by a flap having a concave lower surface.

The device can be a spoiler flap, hinged at its rear or forward edge or nearer the centre, or a deformable skin section, or even a porous or slotted section of the wing surface, through which air can be forced to cause flow separation. The lower spoiler can be used in conjunction with a spoiler or spoilers on the upper surface.

For a better understanding of the invention, embodiments of it will now be described, by way of example, with reference to the accompanying drawings, in which:

FIG. 1 shows the pressure distribution over an aft-loaded wing section;

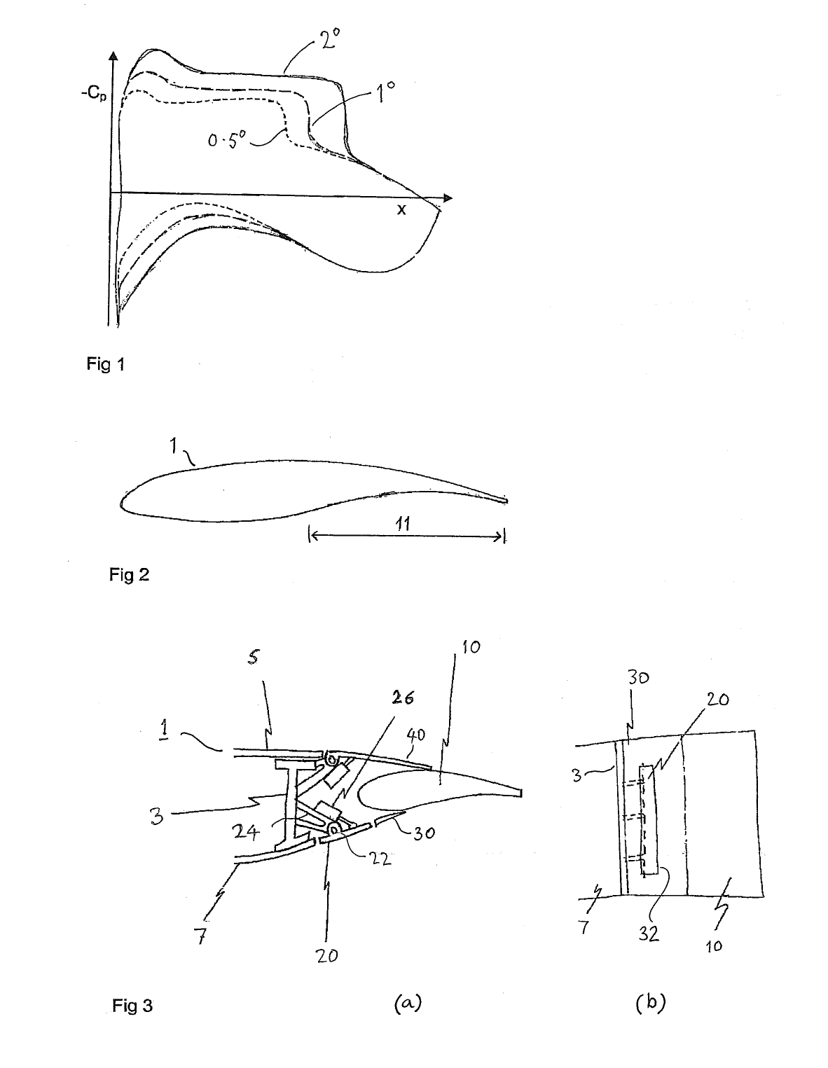

FIG. 2 shows the shape of the wing section;

FIG. 3 shows an embodiment of the invention, in section and from below;

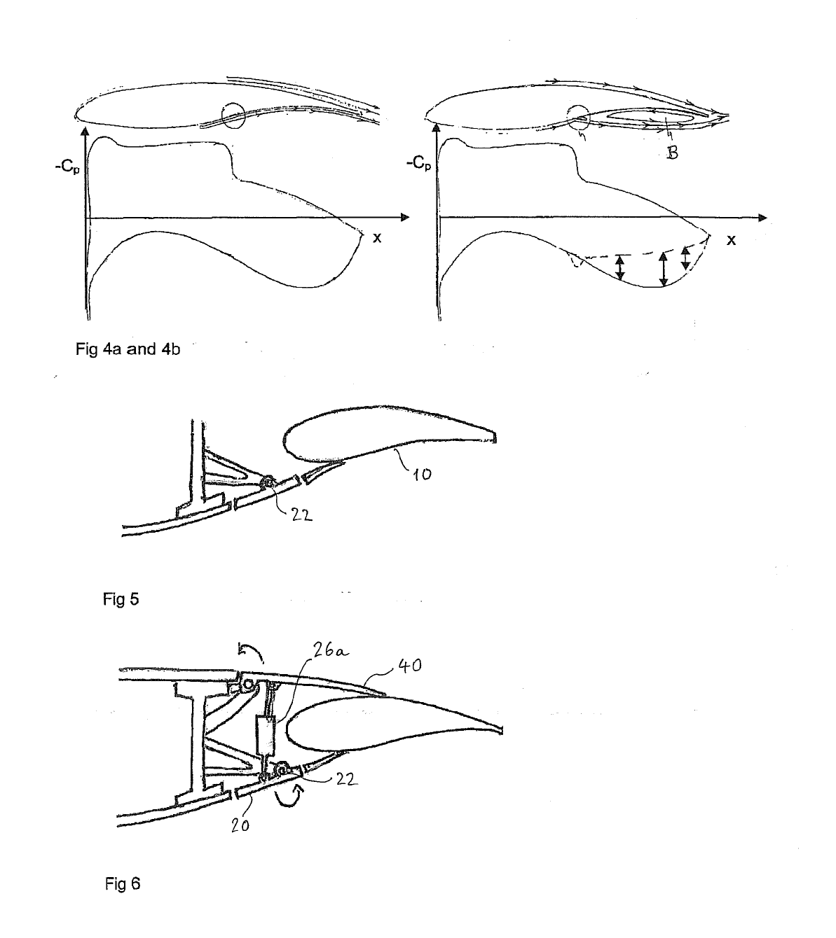

FIG. 4 shows the effect of deploying the spoiler on the lower surface;

FIG. 5 shows a variation of the first embodiment;

FIG. 6 shows a second embodiment, with upper and lower spoilers;

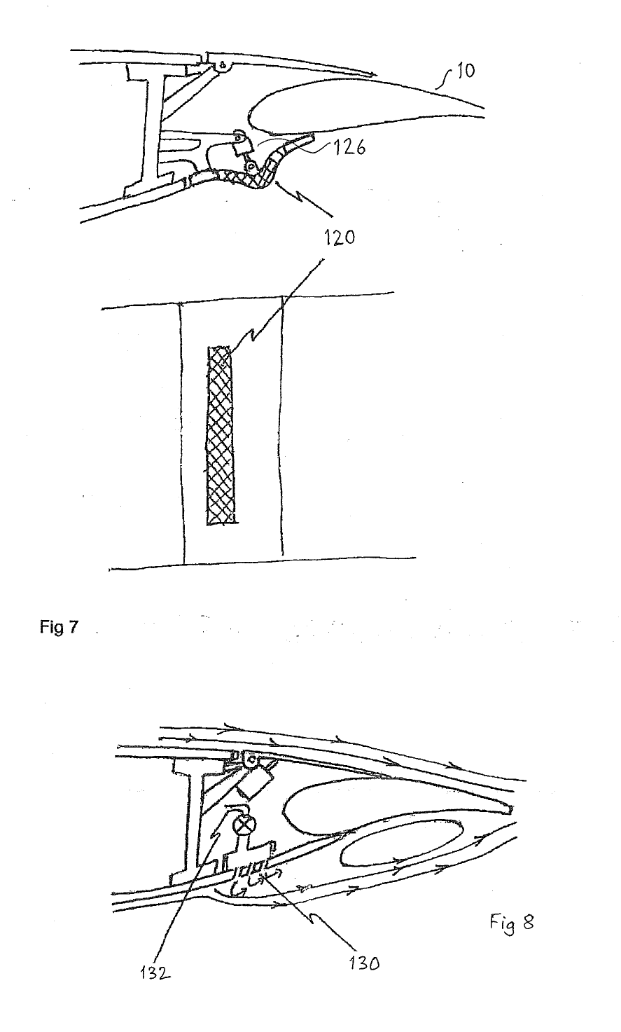

FIG. 7 shows a third embodiment;

FIG. 8 shows a fourth embodiment; and

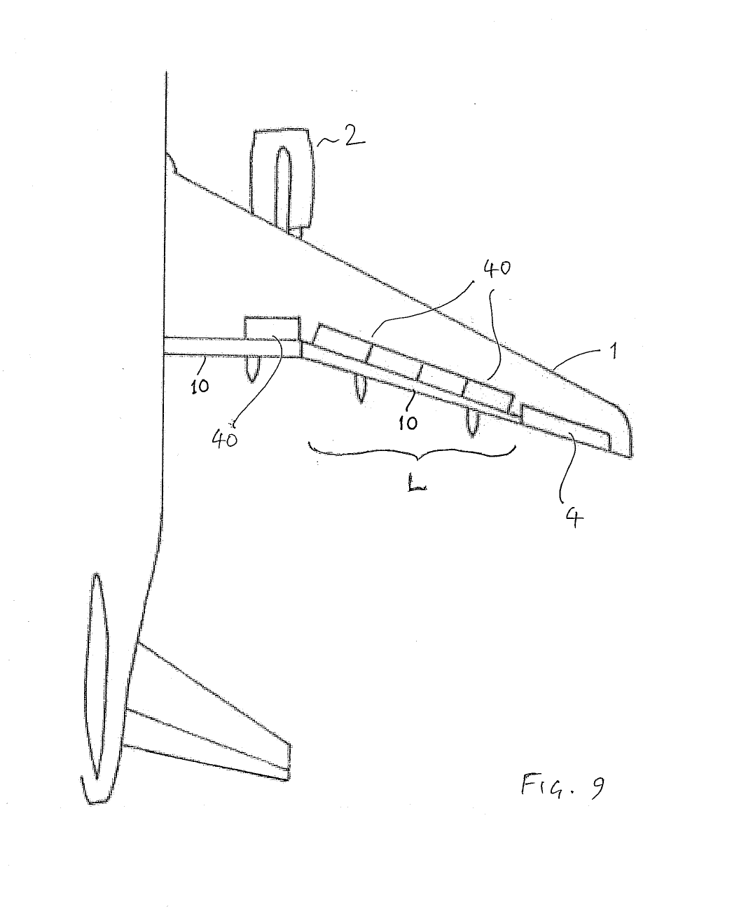

FIG. 9 shows an aircraft wing from above, illustrating the preferred location of the spoiler device.

First, the distribution of pressure along the chord of a wing section will be explained with reference to FIG. 1. In fact, the graph shows a dimensionless pressure coefficient Cₚ, but it will be referred to as “pressure” for brevity. Pressure decreases as one moves up the y axis. The section itself is shown in FIG. 2. The leading edge is at zero on the x-axis. The upper half of the y-axis shows the (under-)pressure above the wing, the lower half the excess pressure below the wing. As can be seen, the airfoil shape is a supercritical or aft-loaded shape typical of modern transonic wing designs, concave over the rear part 11 of its lower surface. The pressure underneath the wing 1 decreases from an initial peak, and then gradually increases again typically just aft of the maximum thickness and finally decreases fairly sharply towards the trailing edge. Above the wing there is a small suction peak at the leading edge, a long plateau and then a sudden increase in pressure at a shock wave where the airspeed turns from supersonic to subsonic and then a more gradual recompression to the trailing edge (assuming the flow is not separated).

FIG. 1 shows three different curves, the dotted line representing an angle of incidence of 0.5°, the dashed line 1° and the solid line 2°. The curves are generally the same shape, pressure values increasing with angle of incidence, but it will be observed that the pressure under the rear section of the wing starting a short distance aft of the wing maximum section thickness, say somewhat less than half its extent, is essentially independent of the angle of incidence.

The resultant lift is given by the area of the curved shape. There is a significant lift component arising from the rear wing section, and the present invention aims to adjust this contribution by the use of a spoiler (or device to give a similar effect to a spoiler) in the rear lower section of wing.

FIG. 3 illustrates a first embodiment of the invention, showing (in FIG. 3a) a partial section through a wing rear section and, in FIG. 3b, a view on part of the wing 1 from below. The general wing shape is given by top and bottom covers 5, 7, supported by a framework represented in the diagram by the rear spar 3. The trailing edge of the wing at this point is constituted by a flap 10 supported by levers, not shown. In the wing box or shroud 30 making the transition from the main wing covers to the flap there is a slot 32 in the lower surface. The slot is occupied by a spoiler 20 mounted on a longitudinal axis or hinge line 22, itself supported on brackets 24 attached to the rear spar 3 of the wing. The hinge line can be parallel to the rear spar or a few degrees off parallel if the wing is tapered. An actuator 26, which could be hydraulic or electric, for instance, acts on the spoiler to the rear of the hinge 22 to deploy the spoiler outwardly into the airstream.

When the spoiler is deployed it has the effect of causing flow separation in the rear part of the wing, forming a “bubble” B of air circulation. This is illustrated in FIG. 4. FIG. 4a shows the uninterrupted flow, as would obtain for typical 1 g cruise conditions, FIG. 4b the flow with the spoiler deployed.

It can be seen from the latter Figure that a considerable amount of lift is destroyed by the deployment of the spoiler. Such deployment can be carried out when the aircraft experiences a gust, encounters turbulence or has to execute a manoeuvre during cruise, in order to avoid excess loads on the wing, and in particular on the mid- to outer parts of the wing. After the need has passed, the spoiler can be stowed again. This can be carried out automatically by the on-board control system.

Instead of being hinged near the upstream edge as in FIG. 3, the spoiler can be hinged near the mid-chord (FIG. 5) or even near the downstream edge (FIG. 6). The former configuration balances the aerodynamic load forward and aft of the hinge line, which lowers the actuation force required. At least in the embodiment of FIG. 6, the majority, preferably at least three-quarters, of the surface of the spoiler is deployed outwardly of the remaining wing surface.

There will usually already be a spoiler on the upper surface of the wing. This is shown at 40 in FIG. 3a. There will be at least some overlap in the wing span direction, making it possible to use a common actuation mechanism for the two spoilers, as in the FIG. 6 embodiment. This leads to a reduction in weight. In this variant the lower surface spoiler has a hinge line near the trailing edge, the actuator 26a acting roughly in the middle, and the upper spoiler has a hinge line at the leading edge, the actuator acting a little way downstream. The actuation loads for deployment and stowage can then roughly balance. That is, when the spoilers are stowed, the force acting to close the lower spoiler roughly balances the force (under-pressure) acting to open the upper spoiler, and contrariwise when the spoilers are deployed.

FIG. 7 shows a further embodiment, in which the spoiler is not a hinged flap but an area or sheet of flexible or morphing material 120, acted on from inside the wing by an actuator 126. This sheet of material is stiff enough to hold its shape during 1 g cruise when the actuator is in its stowed condition, but can be caused to bulge into the air flow by an actuator.

Again, the bump should be big enough to cause flow separation lasting at least to the trailing edge of the wing. An advantage of this system is that no gap is needed between the spoiler and the lower surface shroud or fairing, which reduces drag and the need for gap sealing.

In a further alternative, shown in FIG. 8, the relevant section of the lower wing surface can be porous or have small holes 130, through which air is fed 132 from a high-pressure source such as an engine bleed or onboard pump. The air can be injected into the airstream at an acute angle (i.e. partly into the oncoming air), in the range 0° to 45° to the surface normal.

In general the invention makes possible a reduction in wing loads and therefore structural weight, as the lower surface spoiler when deployed reduces that component of the lift force that would normally be generated by the rearward portion of the wing lower surface. The lift component in this region cannot be influenced by the upper surface spoiler acting on its own. Therefore when used in combination with an upper surface spoiler an increase in the wing LAF is possible compared to a wing with only an arrangement of upper surface spoilers. Alternatively the use in combination with an upper spoiler allows, for the same LAF, a smaller upper surface spoiler and concomitant reduction in weight of its actuator, especially if the same actuator is used for both spoilers.

As indicated by the letter L in FIG. 9, which schematically shows a wing 1 with aileron 4 and engine 2, the lower-side spoiler device, which may consist of a number of spoilers, is usually best placed in the mid-section of the wing 1. This region L runs from the inboard edge of the aileron to the inboard edge of the bank of four upper spoilers 40 near the angled rear wing edge. The upper spoilers 40, or at least those in the corresponding area, can then be actuated at the same time as the lower.

FIG. 9 also shows inboard and mid-board flaps 10 at the trailing edge of the wing, partly covered (during cruise) by the upper spoilers 40 or the wing itself, and extending all the way out to the aileron 4. The majority at least of the concave rear lower surface of the wing will be presented by the flaps. Although the embodiments shown illustrate a spoiler deice associated with a flap at the trailing edge of the wing, such a device could alternatively or additionally be located at a part of the wing where the trailing edge has a fixed section.

We claim:

1. An aircraft wing, comprising:
an upper surface;
a lower surface having a rear part comprising a concave portion over at least some of its length; and a spoiler device, located forward of at least part of the concave portion and aft of a thickest part of the wing as defined by a distance between the upper surface and the lower surface, the spoiler device operable to change between a first configuration in which the lower surface is uninterrupted and a second configuration in which the spoiler device separates flow, so as to reduce a lift force at the concave portion.

2. A wing according to claim 1, wherein the spoiler device includes a deployable spoiler.

3. A wing according to claim 2, wherein the spoiler device further includes an actuator for deploying the deployable spoiler.

4. A wing according to claim 3, wherein the actuator is configured to deploy the deployable spoiler outwardly into an airflow outside the lower surface of the wing.

5. A wing according to claim 2, wherein the deployable spoiler is a first spoiler, and wherein the wing comprises a second spoiler located on the upper surface of the wing.

6. A wing according to claim 5, wherein the first spoiler and the second spoiler are operated by a single actuator.

7. A wing according to claim 1, in which the spoiler device includes at least one of a flexible or a deforming material operable to protrude from the lower surface.

8. A wing according to claim 1, in which the spoiler device includes a permeable area of the lower surface, through which air can be expelled to cause flow separation.

9. A wing according to claim 1, wherein the spoiler device is located at a forward-most edge region of the concave portion.

10. A wing according to claim 1, wherein the spoiler device is located in a mid-section of the wing span.

11. A wing according to claim 1, wherein an aft part of the wing is constituted at least partly by one or more flaps having a concave lower surface.

12. An aircraft having a pair of wings, each wing comprising:
an upper surface;
a lower surface comprising a rear part comprising a concave portion over at least some of its length; and
a spoiler device located forward of at least part of the concave portion and aft of a thickest part of the wing as defined by distance between the upper surface and the lower surface,
the spoiler device being operable to change between a first configuration in which the lower surface is uninterrupted and a second configuration in which the spoiler device separates flow, so as to reduce a lift force at the concave portion.

13. A method of controlling an aircraft having wings, the wings each comprising an upper side and an underside, the method comprising:
actuating a control surface on the underside of each wing so as to cause flow separation over a concave portion of a rear part of each wing during flight of the aircraft to reduce lift on the wings.

14. A method according to claim 13, further comprising:
actuating a control surface on the upper side of each wing simultaneously with actuating the control surface of the underside.

15. A method according to claim 13, wherein the actuating a control surface comprises deploying a deployable spoiler.

16. A method according to claim 15, wherein actuating the control surface comprises actuating an actuator for deploying the deployable spoiler.

17. A method according to claim 16, wherein the deployable spoiler is deployed outwardly into an airflow outside the underside of the wing.

18. A method according to claim 14, wherein actuating the control surface on the upper side of a first wing and actuating the control surface on the underside surface of a first wing is conducted with a single actuator.

19. A method according to claim 13, in which the control surface includes at least one of a flexible or a deforming material operable to protrude from the wing surface.

20. A method according to claim 13, in which the control surface includes a permeable area of the underside, through which air can be expelled to cause flow separation.
